(19) United States
(12) Patent Application Publication
(10) Pub. No.: US 2025/0101296 A1
(43) Pub. Date: Mar. 27, 2025

(54) REAGENT FOR ACRIDINIUM ESTER CHEMILUMINESCENCE INCLUDING GRAPHENE OXIDE, REAGENT SYSTEM INCLUDING THE SAME, AND METHOD OF DETECTING TARGET ANTIGEN USING THE SAME

(71) Applicant: Ji Hoon LEE, Gaithersburg, MD (US)

(72) Inventors: Ji Hoon LEE, Gaithersburg, MD (US); Tracy Jeong-Eun LEE, Gaithersburg, MD (US); Yoon Yoo JO, Tenafly, NJ (US); Riley Donghyun YOO, Portland, OR (US); Elliot Seunghyun YOO, Portland, OR (US)

(21) Appl. No.: 18/372,034

(22) Filed: Sep. 22, 2023

(51) Int. Cl. C09K 11/07; G01N 21/76

(52) U.S. Cl. CPC C09K 11/07; G01N 21/76

(57) ABSTRACT

Provided is a reagent for acridinium ester chemiluminescence, including a graphene-based material; hydrogen peroxide; and an acid, and a reagent system including the same, and a method of detecting a target antigen in a sample, including: performing immunoreaction between a target antigen in a sample with a detection antibody or an artificial antigen consistent with the target antigen conjugated with acridinium ester to form an acridinium ester-labeled immunocomplex; dispersing the acridinium ester-labeled immunocomplex in a first reagent comprising an acid, hydrogen peroxide and a graphene-based material; adding a second reagent including a base and a surfactant into the dispersed acridinium ester-labeled immunocomplex to emit chemiluminescence signal; and measuring an intensity of the chemiluminescence signal.

### TECHNICAL FIELD

This disclosure describes a reagent for acridinium ester chemiluminescence, a reagent system including the same, and a method of detecting target antigen using the same.

### BACKGROUND

Details in the background section do not constitute the related art but are given only as background information concerning the subject matter of the present disclosure.

Acridinium ester chemiluminescence has been known as a popular direct detection method for immunoassays that does not require enzyme labels like horseradish peroxidase (HRP) or alkaline phosphatase (AP). In a typical sandwich immunoassay using this technique, the detection antibodies are conjugated with acridinium ester. After the immunoreaction between sample antigens and the detection antibodies, a certain volume (e.g., 100-300 μL) of high concentration hydrogen peroxide (e.g., 100-200 mM) in a strong acid (e.g., 0.1 N of HNO₃ or H₂SO₄) is added to the assay well. This rapidly disperses and stabilizes the acridinium ester-labeled immunocomplex in the acidic solution. Once an equilibrium condition is reached, a certain volume (e.g., 100-300 μL) of concentrated sodium hydroxide (e.g., 250-500 mM) is injected. The strong basic solution (>pH 13) triggers the acridinium ester to produce a flash of blue chemiluminescence as shown in FIG. 1. While acridinium ester chemiluminescence provides more sensitive detection for sandwich immunoassays compared to enzyme-based chemiluminescence, there are some downsides to this approach.

For example, the concentrated reagents used in the process-hydrogen peroxide, strong acids, and strong bases—can be hazardous. Handling and disposing of these materials require special precautions to avoid environmental issues. Additionally, depending on the reagents and buffer agents, the acridinium esters may exhibit background luminescence in the absence of the target analyte. This non-specific signal can potentially interfere with the accuracy of the assay and may necessitate additional steps to reduce background noise.

Therefore, there is a need to develop a new reagent for performing the acridinium ester chemiluminescence which is environmentally friendly, cost-effective, low signal to background ratio, higher sensitivity and faster performance.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure has been made to solve the above-mentioned problems and other technical problems that have yet to be resolved.

An object of the present disclosure is to provide a reagent and a reagent system for acridinium ester chemiluminescence which enable faster and highly sensitive acridinium ester chemiluminescence.

Another object of the present disclosure is to provide a method of detecting a target antigen in a sample using reagents which is environmentally friendly, cost-effective, low signal to background ratio, higher sensitivity and faster performance.

In order to achieve the above object, according to an exemplary embodiment, the present disclosure can provide a reagent for acridinium ester chemiluminescence, comprising: a graphene-based material; hydrogen peroxide; and an acid.

The graphene-based material can be selected from the group consisting of graphene, graphene oxide (GO), and reduced graphene oxide (rGO). The concentration of the graphene-based material can be 0.7 μg/ml or more, or preferably, 0.7 μg/ml or more and 200 μg/ml or less.

The acid can be selected from the group consisting of nitric acid, hydrochloric acid, ascorbic acid, citric acid, formic acid, oxalic acid and a combination thereof. The concentration of the acid can be less than 200 mM.

The concentration of the hydrogen peroxide can be less than 50 mM, or less than 20 mM.

According to another exemplary embodiment, the present disclosure can provide a reagent system for eliciting an acridinium ester chemiluminescence comprising: a first reagent including a graphene-based material, hydrogen peroxide, and an acid; and a second reagent including a surfactant and a base.

The base can be selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof. The concentration of the base in the second reagent is less than 200 mM.

The pH of the second reagent can be 10 to 13.

The surfactant can be selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS). The concentration of the surfactant can be 0.1 mM to 100 mM.

According to yet another exemplary embodiment, the present disclosure can provide a method of detecting a target antigen in a sample comprising: performing an immunoreaction between a target antigen in a sample with a detection antibody or an artificial antigen consistent with the target antigen conjugated with acridinium ester to form an acridinium ester-labeled immunocomplex; dispersing the acridinium ester-labeled immunocomplex in a first reagent comprising an acid, hydrogen peroxide and a graphene-based material; adding a second reagent including a base and a surfactant into the dispersed acridinium ester-labeled immunocomplex to emit a chemiluminescence signal; and measuring an intensity of the chemiluminescence signal.

In the dispersing step, the acridinium ester-labeled immunocomplex and the first reagent can be mixed and incubated for less than 5 minutes, or preferably less than 1.5 minutes to reach equilibrium binding condition.

The sample can be selected from the group consisting of serum, plasma, whole blood, stool, cerebrospinal fluid, synovial fluid, tissue, nasal swabs, and urine from humans or animals. The sample also can be selected from the group consisting of drinking water, tap water, vegetables, fruit, meat, and contaminated materials. The target antigen can be an antigen derived from bacteria, cells, foodborne pathogens, peptides, proteins, haptens, or viruses. The target antigen also can be small molecule antigens, non-protein antigens, cyclic antigens, scarce antigens, single epitope antigens, or obscured epitope antigens. The step of measuring the intensity of the chemiluminescence signal can be performed less than 20 seconds after adding the second reagent.

In the above-described method, the graphene-based material can be selected from the group consisting of graphene, graphene oxide (GO), and reduced graphene oxide (rGO) and the concentration of the graphene-based material in the first reagent can be 0.7 μg/ml or more.

In the above-described method, the acid can be selected from the group consisting of nitric acid, hydrochloric acid, ascorbic acid, citric acid, formic acid, oxalic acid and a combination thereof. The concentration of the acid in the first reagent can be less than 200 mM.

In the above-described method, the concentration of the hydrogen peroxide can be 50 mM or less.

In the above-described method, the base can be selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof. The concentration of the base in the second reagent can be less than 200 mM.

In the above-described method, the pH of the second reagent can be 10 to 13.

In the above-described method, the surfactant can be selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS). The concentration of the surfactant can be 0.1 mM to 100 mM.

In the above-described reagent system for eliciting an acridinium ester chemiluminescence, wherein, in the first reagent, the graphene-based material can be included in an amount of 0.7 μg/ml or more, and can be one or more selected from the group consisting of graphene, graphene oxide (GO), and reduced graphene oxide (rGO), wherein, in the first reagent, the hydrogen peroxide can be included in an amount of less than 50 mM, and wherein, in the first reagent, the acid can be included in an amount of less than 200 mM, and can be one or more selected from the group consisting of nitric acid, hydrochloric acid, ascorbic acid, citric acid, formic acid, oxalic acid and a combination thereof, wherein, in the second reagent, the surfactant can be included in an amount of 0.1 mM to 100 mM, and can be one or more selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS), and wherein, in the second reagent, the base can be included in an amount of less than 200 mM, and can be selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 shows a schematic view of acridinium ester chemiluminescence sandwich immunoassay in a related art using the concentrated H₂O₂ in strong acidic reagent containing the high concentration of HNO₃ and strong basic reagents containing concentrated NaOH and Triton X-100.

FIG. 2 shows a schematic view of acridinium ester chemiluminescence sandwich immunoassay according to the present disclosure using 7.25 mM H₂O₂ in weak acidic reagent containing 1 mM citric acid and mild basic reagents containing 10 mM TEA and 30 mM SDS.

FIG. 3 is a graph showing the effect of graphene oxide (GO) in acridinium ester chemiluminescence reaction with the additions of mild acidic and basic in the absence of Triton X-100 under various GO concentrations.

FIG. 4 is a graph showing the effect of graphene oxide (GO) in acridinium ester chemiluminescence reaction with the additions of mild acidic and basic containing 1.8 mM Triton X-100 under various GO concentrations.

FIG. 5 shows a schematic view of the role of graphene oxide (GO) to enhance acridinium ester chemiluminescence according to the present disclosure.

FIG. 6 is a graph showing the synergic effect from the compositions of graphene oxide (GO) and Triton X-100 in mild acidic or mild basic solution.

FIG. 7 is a graph showing the effect of graphene oxide (GO), reduced GO, and graphene in acridinium ester chemiluminescence according to the present disclosure.

FIG. 8 is a graph showing the effect of H₂O₂ with various concentrations in mild acidic reagent containing 1 mM HNO₃ and 25 μg/ml graphene oxide (GO) according to the present disclosure.

FIG. 9 is a graph showing the effect of HNO₃ with various concentrations in acridinium ester chemiluminescence reaction according to the present disclosure. The mild acidic reagents contain 3.13 mM H₂O₂ and 25 μg/ml graphene oxide (GO). The mild basic reagent contains 12.5 mM NaOH and 1.8 mM Triton X-100.

FIG. 10 is a graph showing the effect of various acids in acridinium ester chemiluminescence reactions. The mild acidic reagents contain 3.13 mM H₂O₂ and 25 μg/ml GO. The mild basic reagent contains 12.5 mM NaOH and 1.8 mM Triton X-100. The conventional strong acidic reagent contains 100 mM H₂O₂ and 100 mM HNO₃. The conventional strong basic reagent contains 0.25 M NaOH and 30 mM triton X-100.

FIG. 11 is a graph showing the effect of various incubation times to attain equilibrium conditions according to the present disclosure.

FIG. 12 is a graph showing the effect of various NaOH concentrations in acridinium ester chemiluminescence reaction with mild acidic and basic in the presence of graphene oxide (GO).

FIG. 13 is a graph showing the effect of various bases in acridinium ester chemiluminescence reactions with mild acidic and basic reagents containing graphene oxide (GO).

FIG. 14 is a graph showing the effect of Triton X-100 under various concentrations in acridinium ester chemiluminescence with mild acidic and basic reagents containing graphene oxide (GO).

FIG. 15 is a graph showing the effect of various Triton X derivatives in acridinium ester chemiluminescence with mild acidic and basic reagents containing graphene oxide (GO).

FIG. 16 is a graph showing the effect of anionic, cationic, and neutral surfactants in acridinium ester chemiluminescence reactions with mild acidic and basic reagents containing graphene oxide (GO). (Concentrations of surfactants: [Triton X-100]=1.8 mM, [SDS]=30 mM, [ADS]=2.5 mM, [Tween 20]=6.5 mM, [SPAN 20]=16 mM, [γ-cyclodextrin]=10 mM, [CTAC]=7 mM, and [CTAB]=6 mM).

FIG. 17 is a graph showing the effect of various acids in acridinium ester chemiluminescence reactions. (The mild acidic reagents contain 3.13 mM H₂O₂ and 25 μg/ml graphene oxide (GO). The mild basic reagent contains 12.5 mM NaOH and 30 mM SDS. The conventional strong acidic reagent contains 100 mM H₂O₂ and 100 mM HNO₃. The conventional strong basic reagent contains 0.25 M NaOH and 30 mM triton X-100).

FIG. 18 is a graph showing the quantification of CEA in human serum using sandwich immunoassay with acridinium ester chemiluminescence detection using mild acidic and basic reagents or conventional reagents.

FIG. 19 is a graph showing the combination effect of mild acidic and basic solutions. (Conventional: 100 mM HNO₃, 100 mM H₂O₂, 250 mM NaOH, 0.3% Triton X-100, Combination 1:1 mM HNO₃, 6.3 mM H₂O₂, 12.5 mM NaOH, 0.18% Triton X-100, 25 μg/ml graphene oxide (GO), Combination 2:1 mM Oxalic Acid, 6.3 mM H₂O₂, 12.5 mM NaOH, 0.18% Triton X-100, 25 μg/ml GO, Combination 3:1 mM Oxalic Acid, 6.3 mM H₂O₂, 12.5 mM NaOH, 30 mM SDS, 25 μg/ml GO, Combination 4:1 mM Oxalic Acid, 6.3 mM H₂O₂, 10 mM TEA, 30 mM SDS, 25 μg/ml GO).

FIG. 20 is a graph showing the chemiluminescence spectra generated with the pre-activating (first)/activating (second) reagents and two different commercial products such as Acid/Base reagents and Pre-trigger/Trigger solutions.

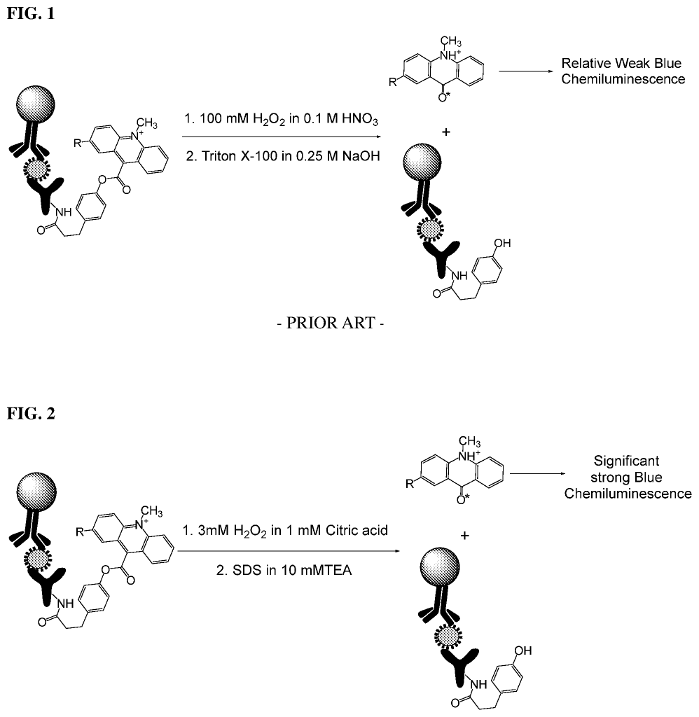

### DETAILED DESCRIPTION

Hereinafter, the present disclosure will be described in more detail for a better understanding of the invention.

While the present disclosure is open to various modifications and alternative embodiments, specific embodiments thereof will be described and illustrated by way of example in the accompanying drawings. However, this is not purported to limit the present disclosure to a specific disclosed form, but it shall be understood to include all modifications, equivalents and substitutes within the idea and the technological scope of the present disclosure. In this application, it should be understood that terms such as “include” or “have” are intended to indicate that there is a feature, number, step, operation, component, part, or a combination thereof described on the specification, and they do not exclude in advance the possibility of the presence or addition of one or more other features or numbers, steps, operations, components, parts or combinations thereof.

Hereinafter, the present disclosure will be described in detail.

According to one embodiment of the present disclosure, a reagent system for acridinium ester chemiluminescence including a first reagent and a second reagent is provided. The present disclosure also provides the first reagent. The first reagent can be used for dispersing and stabilizing the acridinium ester-labeled immunocomplex, and can comprise a graphene-based material, hydrogen peroxide and an acid. The second reagent can be used for triggering the chemiluminescence, and the second reagent includes a base and a surfactant.

The graphene-based material can comprise one or more of graphene, graphene oxide (GO), and reduced graphene oxide (rGO). Preferably, the graphene-based material can be graphene oxide (GO). The graphene-based material can be included in the first reagent in an amount of 0.3 μg/ml or more, 0.5 μg/ml or more, 0.7 μg/ml or more, 1.0 μg/ml or more, 1.5 μg/ml or more, or 3.0 μg/ml or more, and 200 μg/ml or less, 100 μg/ml or less, or 50 μg/ml or less. Preferably, the graphene-based material can be included in the first reagent in a range of 0.7 μg/ml or more and 15 μg/ml or less. The graphene-based material can be included in the first reagent in an amount of 3.126 μg/ml.

Graphene oxide (GO) improves acridinium ester chemiluminescence while reducing reagent hazards. GO contains hydrophilic functional groups (aldehyde, carboxylic, hydroxyl) on its hydrophobic surface, which allow it to act as a surfactant and to stabilize materials in aqueous solutions. Leveraging this capability, the inventors of the present disclosure developed a reagent including graphene-based material for stabilizing the acridinium ester-labeled immunocomplex.

The reagents according to an embodiment of the present disclosure generate acridinium ester chemiluminescence signals with higher signal-to-background ratios compared to traditional strong acid and strong base reagents.

The inventors of the present disclosure found that, with the use of graphene-based material (e.g., GO) in the first reagent, equilibrium conditions are attained rapidly even with lower concentrations of H₂O₂ (3.13 mM) and acid (1 mM). This enables using much lower NaOH concentrations (e.g., 12.5 mM), which are 20-40 times less than conventional methods. This is because, with the remarkably low NaOH concentration enabled by graphene-based material (e.g., GO), stabilization is sufficient to maintain the basic conditions needed to trigger bright acridinium ester chemiluminescence, while keeping background noise low. With the significant enhancement of the sensitivity, the analysis time of immunoassay can be apparently reduced.

According to an embodiment of the present disclosure, the first reagent also includes hydrogen peroxide as an oxidant which oxidizes the ester group of the acridinium ester-labeled immunocomplex. In a conventional acridinium chemiluminescence technique, hydrogen peroxide is included in the first reagent in an amount of about 100-200 mM. However, according to the present disclosure, hydrogen peroxide can be used in an amount less than 50 mM, preferably in an amount less than 20 mM when the graphene-based material is included in the first reagent.

According to an embodiment of the present disclosure, neutral and/or anionic surfactants, such as Triton X-45 (CAS number 9002-93-1), Triton X-100 (CAS number 9036-19-5), Triton X-114 (CAS number 9036-19-5), Triton X-405 (CAS number 9002-93-1), Triton X-705 (CAS number 9036-19-5), Tween 20 (polysorbate 20, CAS 9005-64-5), Tween 40 (polysorbate 40, CAS 9005-66-7), Tween 60 (polysorbate 60, CAS 9005-67-8), Tween 80 (polysorbate 80, CAS 9005-65-6), and ammonium dodecyl sulfate (ADS) and sodium dodecyl sulfate (SDS), can act as enhancers to significantly increase the brightness of chemiluminescence in the presence of low concentrations of NaOH or alternative bases. The above surfactants can be included in the second reagents in an amount of 0.1 mM or more, 0.5 mM or more, 1.0 mM or more, 5.0 mM or more, and 100 mM or less, 50 mM or less, or 20 mM or less.

For example, the inventors of the present disclosure discovered that the signal to background ratio in the GO-stabilized acridinium ester reagents containing 30 mM SDS was up to 30-fold higher than that obtained in the conventional reagents that do not include GO, but that contain 30 mM Triton X-100 or 7 mM cetyltrimethylammonium chloride (CTAC), which is a cationic surfactant.

However, the signal to background ratio in the graphene-based material (e.g., GO)—stabilized acridinium ester reagents containing a cationic surfactant such as CTAC and hexadecyltrimethylammonium bromide (CTAB) was extremely quenched. This is because the acridinium ester and relatively high concentration of cationic surfactant competitively interact with GO. As a result, the brightness of chemiluminescence under the GO-stabilized acridinium ester reagents in the presence of cationic surfactants was significantly reduced. This is because the yield of high-energy intermediate, capable of emitting light, formed from unstable acridinium ester in the presence of cationic surfactants is not as high as those formed from stable acridinium ester in the presence of neutral or anionic surfactants.

The first reagent (graphene-based material-containing stabilizing reagent) can provide additional advantages beyond enabling low NaOH concentrations in the second reagent. It can allow the use of safe, eco-friendly weak acids as alternatives to hazardous strong acids. Examples of the weak acids can include ascorbic acid, citric acid, formic acid, oxalic acid and the combination thereof at around less than 200 mM, less than 150 mM, less than 100 mM, less than 50 mM, less than 30 mM, less than 10 mM, less than 5 mM, or less than 1 mM.

Additionally, low concentrations of milder bases can substitute for concentrated NaOH. Alternative bases can be, for example, potassium hydroxide, sodium carbonate, potassium carbonate, ammonium hydroxide, or tetraalkylammonium hydroxides like tetraethylammonium hydroxide (TEA), tetrapropyl ammonium hydroxide (TPA), tetrabutylammonium hydroxide (TBA) and the combination thereof. The concentration of the base can be less than 200 mM, less than 150 mM, less than 100 mM, less than 50 mM, less than 30 mM, less than 10 mM, less than 5 mM, or less than 1 mM.

Another benefit of the graphene-based material-containing stabilized reagents is that they can generate bright acridinium ester chemiluminescence at a lower pH range of 11-13, or 11-12.7, whereas conventional mixtures without graphene-based material (e.g., GO) require extremely high pH above 13 to produce chemiluminescence.

According to another embodiment of the present disclosure, a method of detecting a target antigen in a sample using the above described first and second reagents is provided. The method can include various immunoassay techniques using acridinium ester chemiluminescence, for example, sandwich immune assay, indirect competitive immunoassay and direct competitive immunoassay. For the sandwich immunoassay and indirect competitive immunoassay, an immunoreaction is performed between a target antigen in a sample and a detection antibody-conjugated acridinium ester, which forms an acridinium ester-labeled immunocomplex. For the direct competitive immunoassay, the immunoreaction is performed between the target antigen and an artificial antigen-conjugated acridinium ester to form an acridinium ester-labeled immune complex. The artificial antigen can be consistent with (or the same as) the target antigen. After performing the immunoreaction, the acridinium ester-labeled immunocomplex is dispersed in the first reagent comprising an acid, hydrogen peroxide and a graphene-based material. And then, a second reagent including a base and a surfactant is added into the dispersed acridinium ester-labeled immunocomplex to emit chemiluminescence signal, and an intensity of the chemiluminescence signal is measured.

In the dispersing step, the acridinium ester-labeled immunocomplex and the first reagent can be mixed and incubated for less than 5 minutes, less than 3 minutes, less than 1.5 minutes, or less than 50 seconds.

The sample can be selected from the group consisting of serum, plasma, whole blood, stool, cerebrospinal fluid, synovial fluid, tissue, nasal swabs, and urine from humans or animals. The sample also can be selected from the group consisting of drinking water, tap water, vegetables, fruit, meat, and contaminated materials.

The target antigen can be an antigen derived from bacteria, cells, foodborne pathogens, peptides, proteins, haptens, or viruses. The target antigen also can be small molecule antigens, non-protein antigens, cyclic antigens, scarce antigens, single epitope antigens, or obscured epitope antigens. According to an embodiment of the present disclosure, the target antigen can be a target material or a target analyte. However, the type of the target antigen is not limited thereto.

In the above-described method, the step of measuring the intensity of the chemiluminescence signal can be performed less than 20 seconds, less than 10 seconds, or 5 seconds, after adding the second reagent.

Hereinafter, preferred examples of the present disclosure, comparative examples compared thereto, and test examples for evaluating the examples are described. However, it will be apparent to those skilled in the art that these examples are merely illustrative of the present disclosure, and various changes and modifications can be made within the scope and technical spirit of the present disclosure, and it goes without saying that such variations and modifications fall within the scope of the appended claims.

### EXAMPLES

### Example 1. Effect of Graphene Oxide Effect Added in Mild Acidic Reagent

Single layer graphene oxide (GO) aqueous dispersion (5 mg/ml) purchased from Goographene (Merrifield, VA) was tested at varying concentrations to determine optimal conditions for enhancing acridinium ester chemiluminescence. A monoclonal CEA antibody (anti-CEA) was purchased from Fitzgerald Industries International located in Acton, MA. Anti-CEA antibody conjugated to acridinium ester (2 ng/ml) in phosphate buffer (pH 7.2) was used as a control.

The control (25 μl) was added to a borosilicate tube placed in a detection cell of a luminometer (Lumat 9507, Berthold Inc.) equipped with two syringe pumps for injecting reagents. 100 μl of a mild acidic reagent containing 1 mM HNO₃ and 7.25 mM H₂O₂, with or without different GO concentrations (0-50 μg/ml), was added via the first pump. After a 40 sec incubation, 100 μl of basic reagent (12.5 mM NaOH) with or without 1.8 mM Triton X-100 was injected by the second pump. Chemiluminescence was measured by the luminometer for 5 sec.

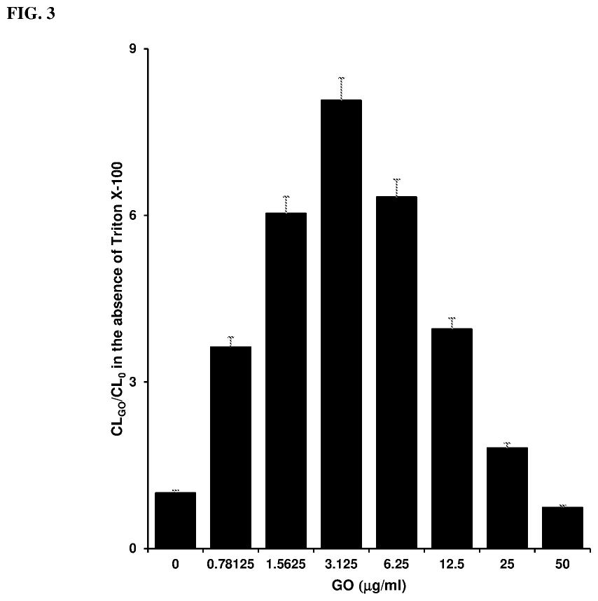

The results are shown in FIG. 3. As shown in FIG. 3, the relative chemiluminescence intensity increased proportionally up to 3.125 μg/ml GO, indicating GO helped stabilize the acridinium ester in the acidic reagent. Above 3.125 μg/ml GO, the intensity decreased without Triton X-100 because the excess GO acts as a quencher of the emission.

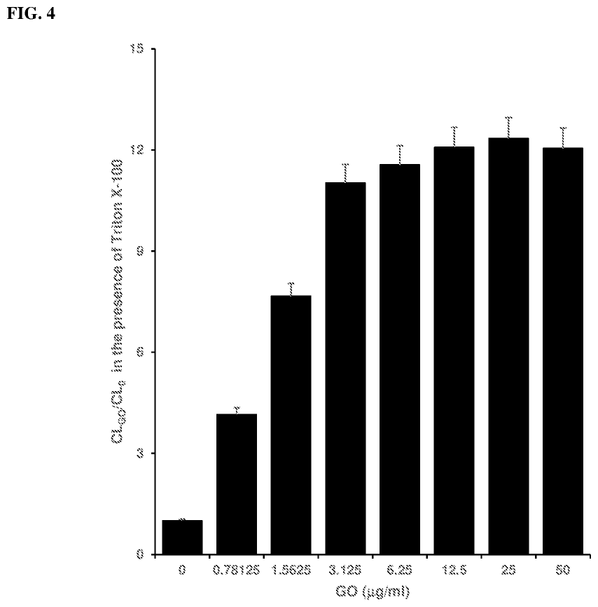

As shown in FIG. 4, the addition of Triton X-100 to the basic reagent reversed the quenching effect of GO. This is because Triton X-100 is a surfactant that can also disperse acridinium esters and prevent them from interacting with GO. As a result, the chemiluminescence intensity was significantly enhanced in the presence of GO and Triton X-100. The optimal GO concentration for enhancing the chemiluminescence intensity was found to be 25 μg/mL. This is because GO can provide the optimal balance of surfactant properties to support the dispersion of acridinium esters at this concentration. Also, FIG. 4 indicates that GO can be selected to emit bright emission under a wide concentration range of 3.125 to 50 μg/ml, in the presence of Triton X-100.

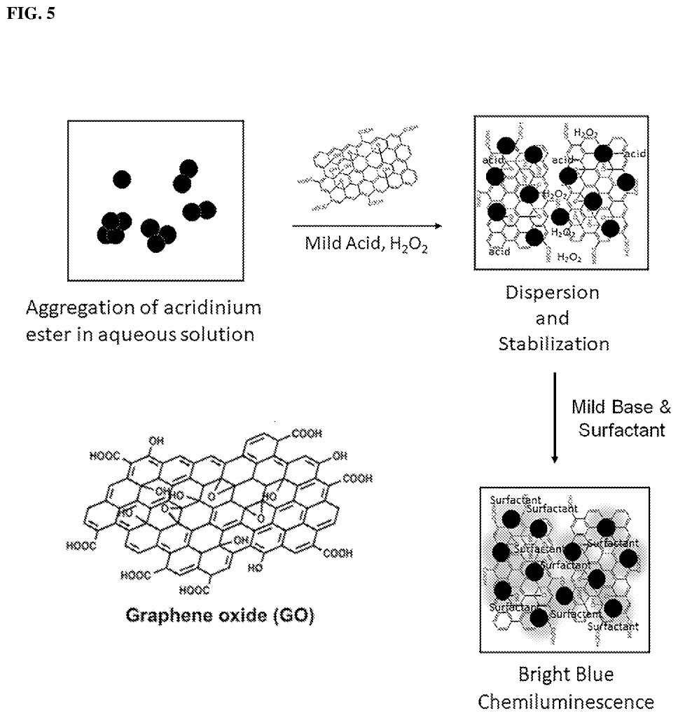

FIG. 5 illustrates a proposed mechanism for how GO enhances acridinium ester chemiluminescence. Due to their hydrophobicity, acridinium ester molecules tend to aggregate in aqueous solution. This aggregation makes it difficult to achieve bright chemiluminescence when adding basic H₂O₂ solution, as the high energy intermediates rapidly decompose through collisions before emitting light.

As shown in FIG. 5, GO in mild acidic H₂O₂ can disperse and stabilize individual acridinium ester molecules under equilibrium conditions. Subsequent addition of basic solution with a specific surfactant allows these dispersed acridinium esters to emit bright chemiluminescence without self-quenching interference from intermediate collisions. The surfactants mixed with GO further support acridinium ester dispersion in the aqueous reagents.

FIG. 3 shows the relative chemiluminescence intensity in solutions containing GO is stronger than that without GO. Also, FIG. 4 indicates that the intensity was further improved by the synergistic effect of combining GO in the mild acidic solution and Triton X-100 in the basic solution.

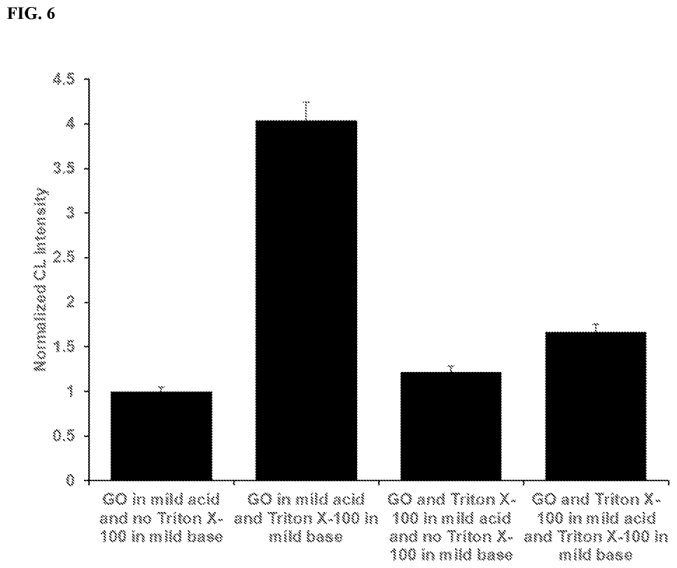

The results in the first and second columns of FIG. 6 align with these findings. The third and fourth columns indicate the relative chemiluminescence intensity depends on the composition of mild acidic and basic solutions.

Column 3 of FIG. 6 shows a low synergistic effect when GO and Triton X-100 are both present in the mild acidic solution, with no Triton X-100 in the basic solution. The intensity was only slightly higher than just graphene oxide alone in the mild acidic solution. Column 4 also reveals an inferior synergistic effect compared to separating GO and Triton X-100 into the mild acidic and basic solutions, respectively.

In summary, FIG. 6 confirms that maximizing the synergistic chemiluminescence enhancement requires GO and Triton X-100 to be present in separate mild acidic and basic solutions, respectively.

### Example 2. Effect of Reduced Graphene Oxide and Graphene in Acridinium Ester Chemiluminescence Reaction

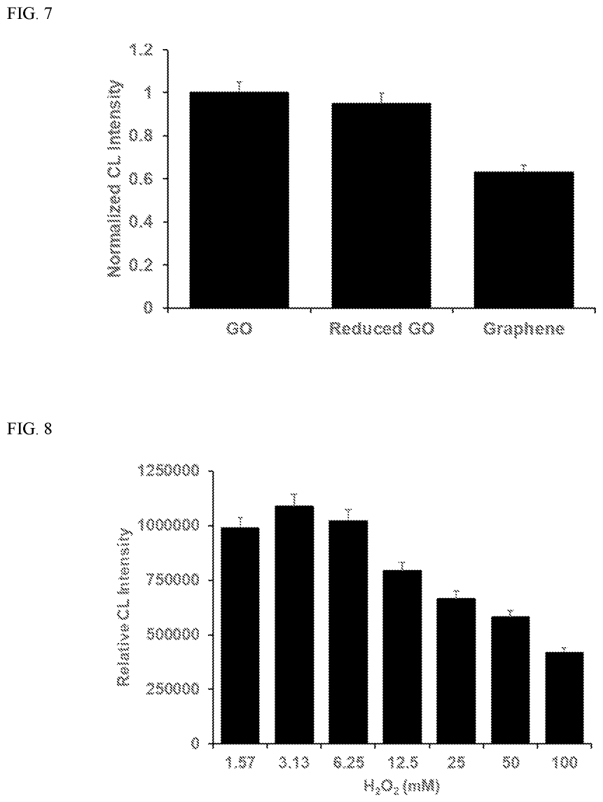

FIG. 7 demonstrates that reduced graphene oxide (rGO) and graphene can also enhance acridinium ester chemiluminescence when present in the mild acidic solution, similar to GO. However, the relative chemiluminescence intensity was lower compared to GO, likely due to differences in hydrophobicity between the materials.

Graphene, with the strongest hydrophobic interactions, provided the lowest enhancement. This suggests GO is the optimal choice for rapidly dispersing and stabilizing acridinium esters in the aqueous reagents, although rGO and graphene still act as surfactants. In conclusion, while both graphene and rGO enhance the chemiluminescence when added to the mild acidic solution, GO provided the highest enhancement of the chemiluminescence with optimal emission intensity without acridinium ester aggregation issues.

### Example 3. Effect of H₂O₂ in Mild Acidic Reagent in Acridinium Ester Chemiluminescence Reaction

The high-energy intermediate responsible for light emission is formed by the reaction of acridinium ester with H₂O₂ under basic conditions. Experiments identified the optimal H₂O₂ concentration in the mild acidic reagent for bright chemiluminescence with the graphene oxide-stabilized acridinium ester system. As shown in FIG. 8, the highest relative chemiluminescence intensity occurred with 3.13 mM H₂O₂, though this relative chemiluminescence intensity was similar to that achieved using 1.57 and 6.25 mM H₂O₂. Thus a concentration of from about 1.57 and 6.25 mM H₂O₂ resulted in high relative chemiluminescence intensity, and this optimal concentration range is much lower than the range of 100-200 mM typically used in conventional strong acid/base reagents.

At H₂O₂ concentrations exceeding 3.13 mM, the relative chemiluminescence intensity proportionally decreased. This reduction is attributed to high concentrations of H₂O₂ promoting rapid formation of the high-energy intermediate from the acridinium ester, resulting in self-quenching of the chemiluminescent reaction.

### Example 4. Effect of Mild Acidic Reagents in Acridinium Ester Chemiluminescence Reaction

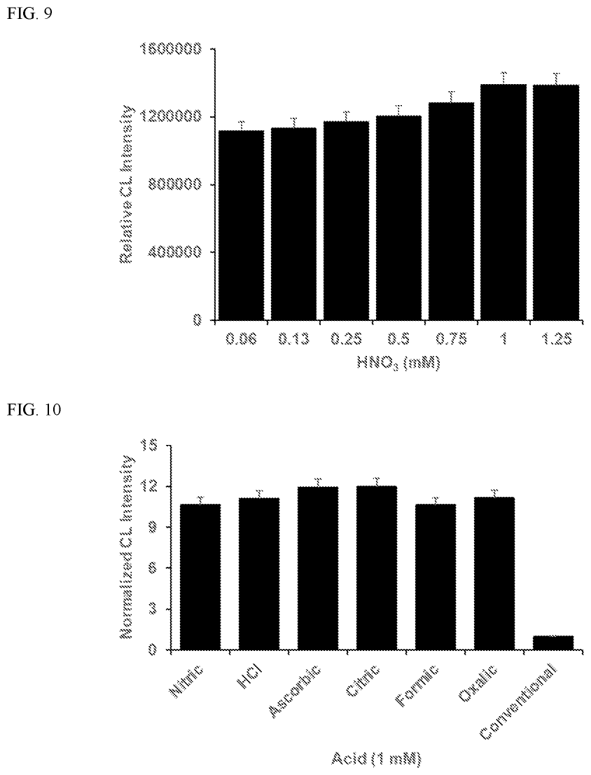

The graphene oxide-stabilized system enables strong chemiluminescence across a wide, mild range of HNO₃ concentrations in the acidic reagent. As shown in FIG. 9, robust signals were achieved with 0.06 to 1.25 mM HNO₃, significantly lower than the 0.1 M (100 mM) typically required without stabilization. Optimal intensity occurred at 1-1.25 mM HNO₃.

Additionally, weak organic acids could effectively substitute for strong mineral acids like HCl and HNO₃ (FIG. 10). The chemiluminescence intensity of acridinium ester in 1 mM of the weak acids ascorbic, citric, formic, or oxalic acid was equal to or surpassed the intensities obtained using 1 mM of strong acids like HCl and HNO₃. This demonstrates that the surfactant properties of graphene oxide allow sufficient stabilization even in dilute, weak acids, generating at least 10-fold greater chemiluminescence compared to 100 mM strong acid without stabilization.

### Example 5. Effect of Incubation Time to Attain Equilibrium Conditions Between Sample and Mild Acidic Reagent

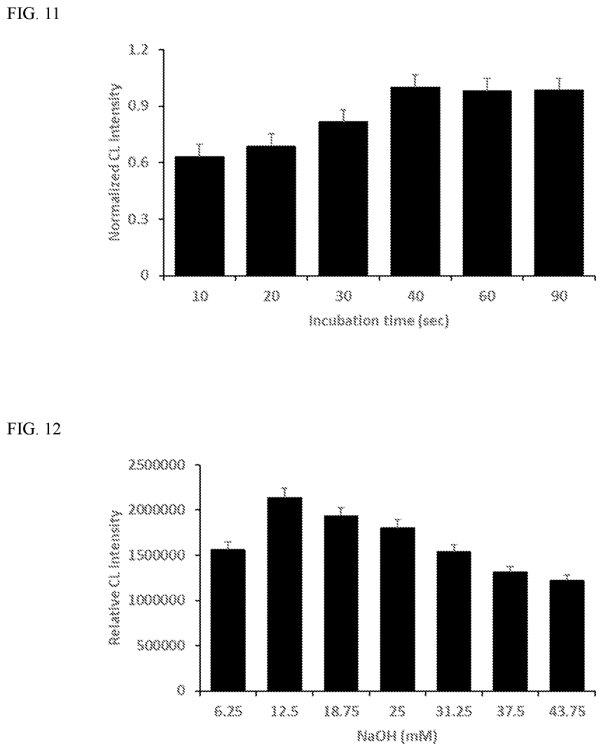

Incubating the acridinium ester conjugate under equilibrium conditions in the mild acidic reagent is necessary for full stabilization and dispersion, as shown in FIG. 11. Anti-CEA-acridinium ester (2 ng/ml) was incubated in 1 mM citric acid, 3.13 mM H₂O₂, and 25 μg/ml GO. After attaining equilibrium, the chemiluminescence brightness upon adding the mild basic reagent (12.5 mM NaOH, 1.8 mM Triton X-100) was consistent regardless of 40, 60 or 90 sec incubation times. This indicates the acridinium ester is fully stabilized under the equilibrium conditions by at least 40 seconds.

FIGS. 10 and 11 demonstrate immunoassays performed with shorter incubations (<40 sec) in the mild reagents exhibit significantly higher sensitivity compared to conventional strong acid/base reagents requiring longer incubation.

### Example 6. Effect of NaOH Concentration in Acridinium Ester Chemiluminescence Reaction Using Mild Acidic and Basic Reagents in the Presence of GO

The optimal NaOH concentration for maximizing chemiluminescence efficiency with the mild reagents is substantially lower than conventional methods, as shown in FIG. 12. The highest signal occurred at just 12.5 mM NaOH, 20-40 times lower than the typical 0.25-0.5 M NaOH used in conventional base reagents.

Additionally, when 0.25 M NaOH traditional base reagent was added, only very weak chemiluminescence was observed. This indicates the GO-stabilized system requires a lower pH range, compared to >pH 13 needed without stabilization. For example, the pH with 1 mM citric acid and 12.5 mM NaOH, used to prepare mild acid and base reagents, was 11.72. Therefore, alternative milder bases can potentially replace NaOH for the mild basic reagent. FIG. 12 indicates that the appropriate pH range to generate bright acridinium ester chemiluminescence in mild acid and base reagents is between 11 and 12.5.

### Example 7. Effect of Alternative Bases in Acridinium Ester Chemiluminescence Reaction Using Mild Acidic and Basic Reagents Containing GO

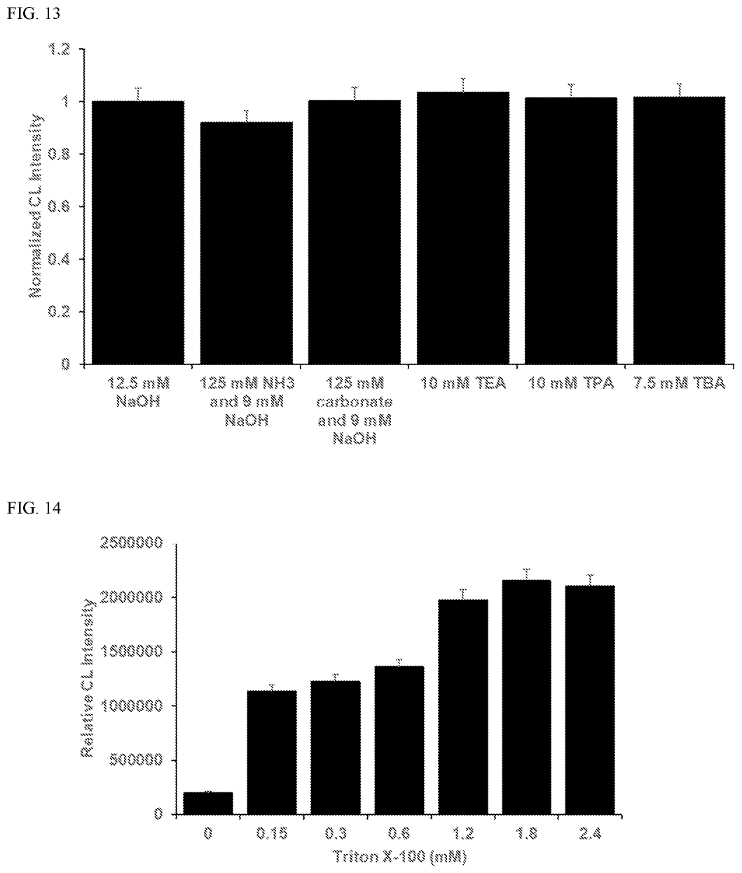

Various alternative mild bases can replace NaOH in the basic reagent containing 1.8 mM Triton X-100, as shown in FIG. 13. Though the optimal concentration varies between bases, robust chemiluminescence was achieved with all of the tested mild bases. Mild bases like ammonia and sodium/potassium carbonate mixed with 9 mM NaOH also generated strong signals within the optimal 11-12.5 pH range.

Additionally, the ability of Triton X-100 to stabilize and disperse the anti-CEA-acridinium ester conjugate was consistent across the different basic reagents tested. This demonstrates the surfactant effect is independent of the base used.

### Example 8. Effect of Triton X Derivatives in Acridinium Ester Chemiluminescence Reaction with Mild Acidic and Basic Reagents Containing GO

The concentration of Triton X-100 in the basic reagent also impacts the chemiluminescence intensity, as shown in FIG. 14. The optimal Triton X-100 concentration in the mild basic reagent was approximately 1.8 mM, much lower than amounts typically used in conventional reagents.

At 1.8 mM Triton X-100, the relative chemiluminescence intensity was over 10 times higher compared to the mild basic reagent without Triton X-100. This demonstrates the significant enhancement provided by the optimal Triton concentration using the mild basic reagent.

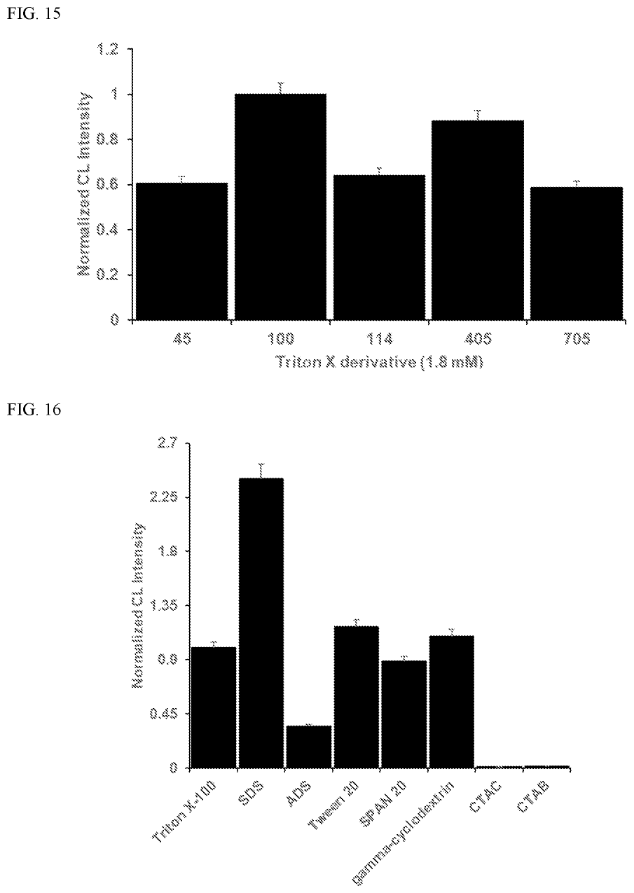

Various commercially available Triton X derivatives can be utilized as surfactants in the mild basic reagent, as shown in FIG. 15. While Triton X-100 provided the greatest enhancement, all tested Triton X forms significantly increased chemiluminescence compared to the reagent without Triton X. This demonstrates the versatility of using Triton X surfactants to boost acridinium ester chemiluminescence in the graphene oxide stabilized mild reaction system.

### Example 9. Effect of Anionic, Cationic, and Neutral Surfactants in Acridinium Ester Chemiluminescence Reactions with Mild Acidic and Basic Reagents Containing GO

The chemiluminescence enhancement provided by various surfactants in the mild graphene oxide reagents depended on surfactant type and properties, as shown in FIG. 16. Optimal concentrations were used for each surfactant to maximize emission intensity.

The anionic surfactant SDS increased chemiluminescence approximately 2.4-fold compared to 1.8 mM Triton X-100, likely due to synergy between the SDS negative charge and GO for the stabilization of the acridinium ester under mild basic conditions.

However, the anionic surfactant ammonium dodecyl sulfate (ADS) only achieved approximately 30% of the chemiluminescence intensity compared to Triton X-100 under the optimized mild conditions. This lower intensity indicates that the specific chemical structure and properties of the surfactant impact emission performance, even between surfactants sharing the same overall charge characteristics. While ADS and SDS are both anionic surfactants, the differences in their molecular structures appear to affect their interaction with the acridinium ester and graphene oxide stabilization system. The dodecyl sulfate head group differs between ADS and SDS, which may explain the large performance gap despite having the same negative charge. This demonstrates that surfactant selection for optimal chemiluminescence enhancement depends on more than just the overall charge, with underlying structural differences able to significantly influence signal intensity.

Neutral surfactants like Tween 20, SPAN 20, γ-cyclodextrin, and Tween derivatives (e.g., Tween 40, Tween 60, Tween 80) performed similarly to Triton X-100 within an acceptable 5% error range. In contrast to the comparable performance of Tween derivatives and γ-cyclodextrin, the chemiluminescence enhancement provided by α- and β-cyclodextrin derivatives (e.g., α-cyclodextrin, β-cyclodextrin, methyl-β-cyclodextrin, carboxymethyl-β-cyclodextrin) under the mild conditions was 40-60% lower than that of Triton X-100. The cyclodextrin compounds all share a cyclic oligosaccharide structure but differ in the arrangement and number of glucopyranose units. The structural variations between α-, β-, and γ-cyclodextrin likely contribute to the differences in interaction with the acridinium ester and GO stabilization system, resulting in lower emission intensity from the α- and β-forms compared to γ-cyclodextrin. The larger cavity size of γ-cyclodextrin may allow better accommodation of the acridinium ester to provide enhanced chemiluminescence.

The cationic surfactants CTAC and CTAB resulted in only ˜1% of the chemiluminescence intensity compared to optimized Triton X-100 under mild conditions. The positive charge on the hydrophilic headgroups of CTAC and CTAB likely causes electrostatic repulsion and interference with the acridinium ester conjugates, which contain an electron-deficient aromatic ring system. This charge-based destabilization disrupts the stabilization interaction between the acridinium ester and the GO surfactant. The results indicate that the acridinium ester conjugates are unable to achieve optimal dispersion in the aqueous reagents without proper stabilization by GO. Additionally, the cationic surfactants appear to bind competitively to the graphene oxide surface, hindering access of the acridinium ester and preventing efficient interaction. The net result is that CTAC and CTAB hinder both acridinium ester stabilization and graphene oxide binding dynamics, evidenced by the dramatic loss of chemiluminescence signal.

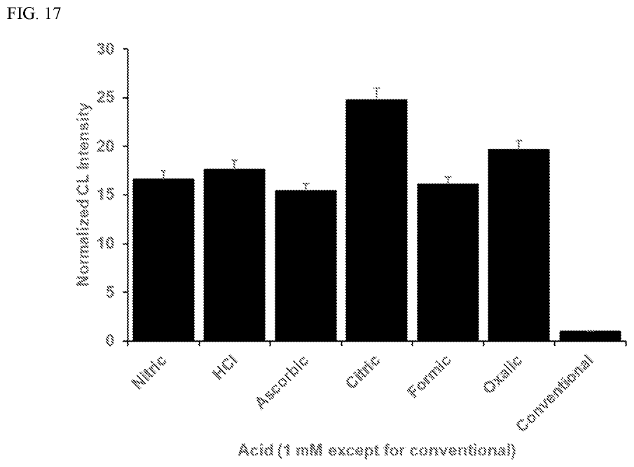

The chemiluminescence enhancement provided by 30 mM SDS depended on the acidic reagent composition, as shown in FIG. 17. The highest intensity occurred with 1 mM citric acid, maximizing the signal increase from SDS under mild conditions. Compared to conventional reagents, the GO-stabilized reagents with citric acid showed approximately 25-fold higher chemiluminescence. Even other weak acids provided at least 15-fold enhancement over traditional strong acid reagents.

This demonstrates that the anionic surfactant SDS outperforms the neutral surfactant Triton X-100 shown previously in FIG. 10, because the negative charge on SDS enables stronger electrostatic interaction and binding with the graphene oxide component compared to the non-ionic Triton X-100. The ionic interaction between the negatively charged sulfate group on SDS and the functionalized surface of GO appears to allow more effective stabilization and dispersion of the acridinium ester conjugate upon introduction of the mild basic reagent. Because Triton X-100 lacks charged groups, it may not undergo the same strong electrostatic association with GO, resulting in relatively weaker stabilization dynamics and consequently diminished chemiluminescence enhancement compared to incorporation of the anionic SDS surfactant.

### Example 10. Improved Speed and Sensitivity of CEA Sandwich Immunoassay Detection Using Graphene Oxide-Stabilized Mild Reagents Compared to Conventional Strong Reagents

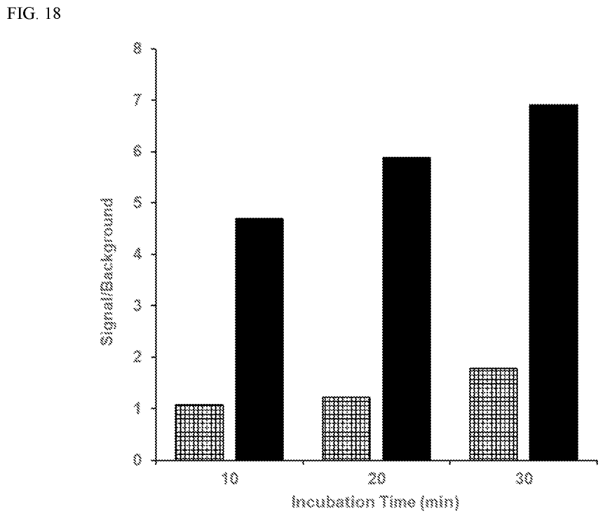

The sensitivity of sandwich immunoassays using the mild vs conventional reagents was compared by detecting 0.2 ng/mL CEA in human serum, as shown in FIG. 18. Sandwich immunoreactions were performed between CEA and a capture antibody on paramagnetic particles, along with a detection antibody conjugated to acridinium ester. After 10-, 20- or 30-min incubation, the immunocomplexes were triggered to produce chemiluminescence using either the mild or conventional acidic and basic reagents.

As shown in FIG. 18, the sandwich immunoassay using the mild reagents reliably detected 0.2 ng/mL CEA after just a 10-min incubation, with a robust signal-to-background ratio (S/B) of 4.7. In contrast, the assay using conventional reagents only showed marginal detection after 30-min incubation, with an S/B ratio of just 1.7.

This demonstrates that the mild reagents enable much faster and more sensitive CEA detection, with sufficient signal after only 10 minutes. Even lower CEA concentrations would likely be detectable with this short incubation. However, conventional reagents require over 30-min incubation to produce enough immunocomplexes for borderline detection sensitivity.

### Example 11. Combination Effect to Enhance Acridinium Ester Chemiluminescence

Graphene oxide (GO), reduced graphene oxide (rGO), or graphene can be added to mild acidic solutions containing low concentrations of H₂O₂ to rapidly disperse and stabilize acridinium ester under equilibrium conditions. Low concentrations of weak acids like ascorbic, citric, formic, or oxalic acid can substitute for strong acids like HCl and HNO₃.

Similarly, mild basic solutions can contain low concentrations of bases such as ammonium hydroxide, carbonate, NaOH, TBA, TEA, or TPA along with surfactants like ADS, cyclodextrins, SPAN 20, Triton X variants, Tween variants, or SDS.

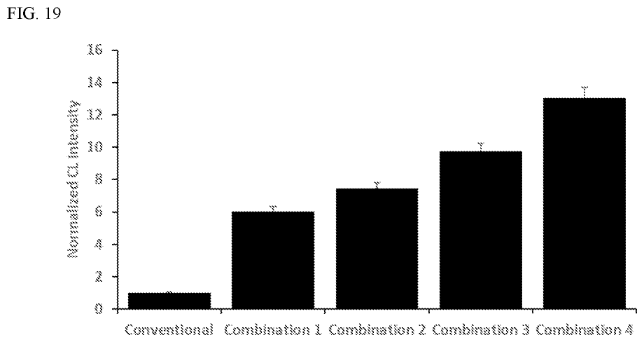

Therefore, various combinations of mild acidic and basic solutions can enhance acridinium ester chemiluminescence. The enhancement depends on the specific compositions as shown in FIG. 19. This matrix highlights the numerous possible combinations of materials that can be used to prepare customized mild acidic and basic solutions for optimized chemiluminescence.

### Example 12. Comparison of New and Commercially Available Reagents

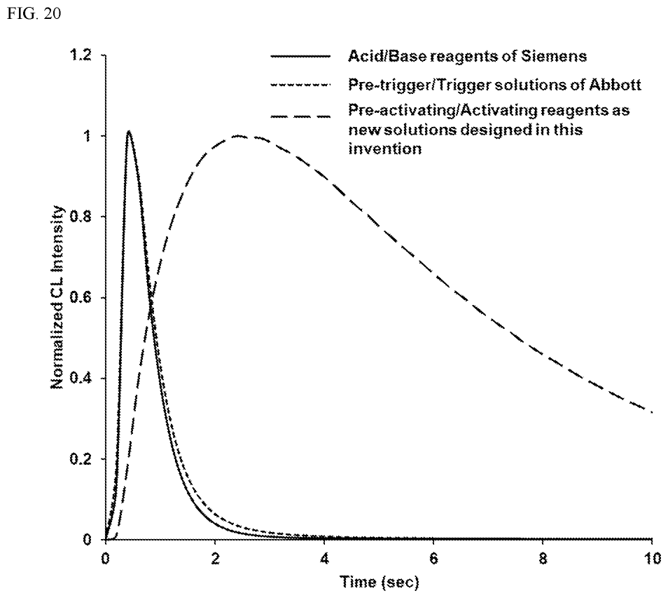

Custom mild acidic and basic solutions were prepared as a variant combination for acridinium ester chemiluminescence and compared to commercially available reagents, as shown in FIG. 20. The mild solutions are termed pre-activating and activating reagents.

The mild acidic solution contained 1 mM citric acid, 6.25 mM H₂O₂, and 25 μg/ml graphene oxide. The mild basic solution contained 10 mM tetraethylammonium hydroxide (TEA) and 30 mM sodium dodecyl sulfate (SDS).

In contrast, conventional acidic reagents used relatively high concentrations of H₂O₂ in strong acids like 0.1 M HNO₃ and 0.5% H₂O₂. Conventional basic reagents contained concentrated NaOH (e.g. 0.25 N) and surfactants like 7 mM cetyltrimethylammonium chloride (CTAC).

Other commercial reagents included pre-trigger solutions (0.0747% HNO₃, 1.32% H₂O₂) and trigger solutions (1.389% NaOH, 1.9841% Triton X-100).

The spectrum of acridinium ester chemiluminescence using the pre-activating and activating reagents shows a completely different shape compared to commercial reagents, as seen in FIG. 20.

The time to reach maximum intensity (tₘₐₓ) was 2.4 seconds for the mild reagents, much longer than the 0.2 seconds for the commercial reagents. Additionally, the mild reagents resulted in a longer chemiluminescence lifetime.

This suggests the emission from the mild graphene oxide-stabilized reagents is more stable than the commercial reagents containing high H₂O₂ concentrations. The rapid kinetics with conventional strong reagents likely generates more transient, short-lived excited states.

While exemplary embodiments of the present disclosure have been described with reference to the accompanying drawings, it will be understood by experts in the art or those of ordinary skill in the art that the present disclosure may be variously modified and changed without departing from the spirit and scope of the present disclosure as defined by the appended claims.

Therefore, the technical scope of the present disclosure should not be limited by the content described in the detailed description of the specification but should be defined by the claims.

What is claimed is:

1. A reagent for acridinium ester chemiluminescence, comprising:
a graphene-based material;
hydrogen peroxide; and
an acid.

2. The reagent for acridinium ester chemiluminescence of claim 1, wherein the graphene-based material is selected from the group consisting of graphene, graphene oxide (GO), and reduced graphene oxide (rGO).

3. The reagent for acridinium ester chemiluminescence of claim 1, wherein the concentration of the graphene-based material is 0.7 μg/ml or more.

4. The reagent for acridinium ester chemiluminescence of claim 3, wherein the concentration of the graphene-based material is 0.7 μg/ml or more and 200 μg/ml or less.

5. The reagent for acridinium ester chemiluminescence of claim 1, wherein the acid is selected from the group consisting of nitric acid, hydrochloric acid, ascorbic acid, citric acid, formic acid, oxalic acid and a combination thereof.

6. The reagent for acridinium ester chemiluminescence of claim 1, wherein the concentration of the acid is less than 200 mM.

7. The reagent for acridinium ester chemiluminescence of claim 1, wherein the concentration of the hydrogen peroxide is less than 50 mM.

8. The reagent for acridinium ester chemiluminescence of claim 7, wherein the concentration of the hydrogen peroxide is less than 20 mM.

9. A reagent system for eliciting an acridinium ester chemiluminescence, comprising:
a first reagent including a graphene-based material, hydrogen peroxide, and an acid; and
a second reagent including a surfactant and a base.

10. The reagent system of claim 9, wherein the base is selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof.

11. The reagent system of claim 9, wherein the concentration of the base in the second reagent is less than 200 mM.

12. The reagent system of claim 9, wherein the pH of the second reagent is 10 to 13.

13. The reagent system of claim 9, wherein the surfactant is selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS).

14. The reagent system of claim 9, wherein the concentration of the surfactant is 0.1 mM to 100 mM.

15. A method of detecting a target antigen in a sample, comprising:
performing an immunoreaction between a target antigen in a sample with a detection antibody or an artificial antigen consistent with the target antigen conjugated with acridinium ester to form an acridinium ester-labeled immunocomplex;
dispersing the acridinium ester-labeled immunocomplex in a first reagent comprising an acid, hydrogen peroxide and a graphene-based material;
adding a second reagent including a base and a surfactant into the dispersed acridinium ester-labeled immunocomplex to emit a chemiluminescence signal; and
measuring an intensity of the chemiluminescence signal.

16. The method of claim 15, wherein in the dispersing step, the acridinium ester-labeled immunocomplex and the first reagent are mixed and incubated for less than 5 minutes to reach an equilibrium binding condition.

17. The method of claim 16, wherein in the dispersing step, the acridinium ester-labeled immunocomplex and the first reagent are mixed and incubated for less than 1.5 minutes to reach an equilibrium binding condition.

18. The method of claim 15, wherein the sample is selected from the group consisting of serum, plasma, whole blood, stool, cerebrospinal fluid, synovial fluid, tissue, nasal swabs, and urine from humans or animals.

19. The method of claim 15, wherein the sample is selected from the group consisting of drinking water, tap water, vegetables, fruit, meat, and contaminated materials.

20. The method of claim 15, wherein the target antigen is an antigen derived from bacteria, cells, foodborne pathogens, peptides, proteins, haptens, or viruses.

21. The method of claim 15, wherein the target antigen comprises a small molecule antigen, a non-protein antigen, a cyclic antigen, a scarce antigen, a single epitope antigen, or an obscured epitope antigen.

22. The method of claim 15, wherein the measuring the intensity of the chemiluminescence signal is performed less than 20 seconds after adding the second reagent.

23. The method of claim 15, wherein the graphene-based material is selected from the group consisting of graphene, graphene oxide (GO), and reduced graphene oxide (rGO).

24. The method of claim 15, wherein the concentration of the graphene-based material in the first reagent is 0.7 μg/ml or more.

25. The method of claim 15, wherein the acid is selected from the group consisting of nitric acid, hydrochloric acid, ascorbic acid, citric acid, formic acid, oxalic acid and a combination thereof.

26. The method of claim 15, wherein the concentration of the acid in the first reagent is less than 200 mM.

27. The method of claim 15, wherein the concentration of the hydrogen peroxide is 50 mM or less.

28. The method of claim 15, wherein the base is selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof.

29. The method of claim 15, wherein the concentration of the base in the second reagent is less than 200 mM.

30. The method of claim 15, wherein the pH of the second reagent is 10 to 13.

31. The method of claim 15, wherein the surfactant is selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS).

32. The method of claim 15, wherein the concentration of the surfactant is in a range of 0.1 mM to 100 mM.

33. The reagent system of claim 9,
wherein, in the first reagent, the graphene-based material is included in an amount of 0.7 μg/ml or more, and is one or more selected from the group consisting of graphene, graphene oxide (GO), and reduced graphene oxide (rGO),
wherein, in the first reagent, the hydrogen peroxide is included in an amount of 50 mM or less, and
wherein, in the first reagent, the acid is included in an amount of less than 200 mM, and is one or more selected from the group consisting of nitric acid, hydrochloric acid, ascorbic acid, citric acid, formic acid, oxalic acid and a combination thereof,
wherein, in the second reagent, the surfactant is included in an amount of 0.1 mM to 100 mM, and is one or more selected from the group consisting of Triton X-45, Triton X-100, Triton X-114, Triton X-405, Triton X-705, Tween 20, Tween 40, Tween 60, Tween 80, sorbitan monolaurate (SPAN 20), γ-cyclodextrin, α-cyclodextrin, β-cyclodextrin, methyl-β-cyclodextrin, carboxymethyl-β-cyclodextrin, ammonium dodecyl sulfate (ADS), and sodium dodecyl sulfate (SDS), and
wherein, in the second reagent, the base is included in an amount of less than 200 mM, and is selected from the group consisting of sodium hydroxide, potassium hydroxide, sodium carbonate, potassium carbonate, ammonium hydroxide, tetraethylammonium hydroxide (TEA), tetrapropyl ammonium hydroxide (TPA), tetrabutylammonium hydroxide (TBA) and a combination thereof.
